(19) United States
(12) Patent Application Publication
(10) Pub. No.: US 2023/0034381 A1
(43) Pub. Date: Feb. 2, 2023

(54) ELECTRONIC DEVICE MOTOR CONTROL BASED ON HINGE TORQUE

(71) Applicant: HEWLETT-PACKARD DEVELOPMENT COMPANY, L.P., Spring, TX (US)

(72) Inventors: Derek Kyle Joseph KANAS, Spring, TX (US); Chan woo PARK, Spring, TX (US); Yung-Yun CHEN, Taipei City (TW)

(21) Appl. No.: 17/386,694

(22) Filed: Jul. 28, 2021

(51) Int. Cl. H02P 29/40; H02K 11/24; G06F 1/16; H02K 7/116; H02K 7/00

(52) U.S. Cl. CPC H02P 29/40; H02K 11/24; G06F 1/1681; G06F 1/1652; H02K 7/116; H02K 7/003

(57) ABSTRACT

An example electronic device includes a housing including a first housing member and a second housing member pivotably coupled to one another via a hinge. In addition, the electronic device includes a motor positioned in the second housing member comprising an output shaft. Further, the electronic device includes an actuatable member positioned in the first housing member, wherein the motor is to actuate the actuatable member via a plurality of gears coupled across the hinge. Still further, the electronic device includes a controller coupled to the motor. The controller is to actuate the motor to reduce a force applied to the output shaft in response to detecting a torque on the hinge.

### BACKGROUND

Electronic devices may comprise actuatable members that may be transitioned between a plurality of states or positions. For instance, an actuatable member may comprise any portion, housing, or component of the electronic device that is to move between a plurality of positions. In some cases, an actuatable member may be moved via a motor, such as, for instance, an electric motor positioned on or within the electronic device.

### BRIEF DESCRIPTION OF THE DRAWINGS

Various examples will be described below referring to the following figures:

FIG. 1 is a schematic view of an electronic device having a motor controlled based on hinge torque according to some examples;

FIG. 2 is a block diagram of the electronic device of FIG. 1 according to some examples;

FIG. 3 is an enlarged schematic side view of the hinge and sensor of the electronic device of FIG. 1 according to some examples; and

FIG. 4 is a block diagram of a method for controlling a motor within an electronic device based on hinge torque according to some examples.

### DETAILED DESCRIPTION

An electronic device may comprise an actuatable member that is actuated or moved via a motor. In addition, an electronic device may comprise multiple housing members that are pivotably coupled to one another via a hinge. However, due to spacing constraints within the housing members, a motor for actuating an actuatable member may not be placed within the same housing member as the actuatable member.

Accordingly, the examples disclosed herein include electronic devices (and methods related thereto) that mechanically link a motor and an actuatable member across multiple pivotable housing members. Some examples disclosed herein may employ systems to prevent both damage to the motor or linkage and unintentional actuation of the actuatable member resulting from forces (e.g., torque) exerted on the housing members and/or the hinge(s) coupled thereto. Thus, through use of the examples disclosed herein, a motor may be distally located (e.g., in another housing member) from an actuatable member of an electronic device without reducing the functionality or reliability thereof.

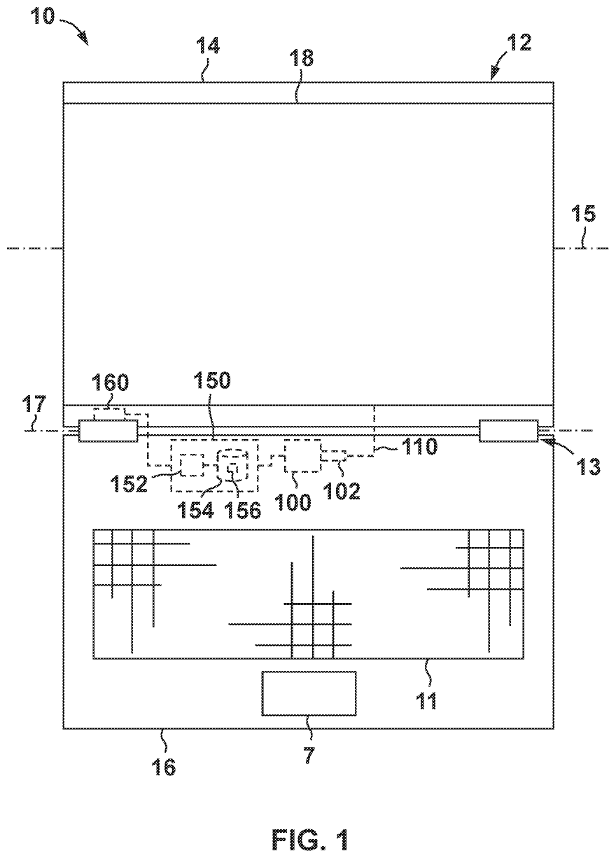

Referring now to FIG. 1, an electronic device 10 having a motor for actuating an actuatable member that is controlled based on hinge torque according to some examples is shown. As used herein, the term “electronic device,” refers to a device that is to carry out machine-readable instructions, and may include internal components, such as, processors, power sources, memory devices, etc. For example, an electronic device may include, among other things, a tablet computer, a laptop computer, a desktop computer, an all-in-one (AIO) computer, a smartphone, etc.

In some examples, the electronic device 10 comprises a laptop computer including a clamshell housing 12. In particular, clamshell housing 12 (or more simply “housing 12”) includes a first housing member 14 and a second housing member 16 coupled to one another via a hinge 13. The hinge 13 may define an axis of rotation 17 for the first housing member 14 and second housing member 16. Thus, during operations, the first housing member 14 may pivot about axis of rotation 17 via hinge 13 relative to second housing member 16, and the second housing member 16 may pivot about axis of rotation 17 via hinge 13 relative to first housing member 14. The first housing member 14 and the second housing member 16 may each be referred to herein as a “housing.” Accordingly, the first housing member 14 may be referred to as a housing 14, and the second housing member 16 may be referred to as a housing 16.

The second housing member 16 supports a plurality of user input devices. For instance, in some examples, the second housing member 16 supports a keyboard 11 (e.g., physical keyboard, digital keyboard) and a touch sensitive surface 7 (e.g., a trackpad). In some examples, second housing member 16 may support a touch sensitive display. During operations, the second housing member 16 may engage with a support surface (e.g., a table, desk, counter-top, floor), such that housing 12 is generally supported on the support surface by second housing member 16.

The first housing member 14 supports a display panel 18, which may comprise any electronic display for displaying text, graphics, images, video, etc. (all of which may be collectively referred to herein as “images”). For instance, display panel 18 may comprise a light emitting diode (LED) display, such as a micro-LED display or an organic LED (OLED) display. In some examples, display panel 18 may comprise a liquid crystal display (LCD), such as an organic LCD, or an electrophoretic display. In some examples, display panel 18 may comprise a touch sensitive or touchscreen display. In addition, display panel 18 may comprise a flexible display panel. As used herein, the term “flexible display panel” refers to a display panel that may be deformed (e.g., rolled, folded, etc.) within a given parameter or specification (e.g., a minimum radius of curvature) without losing electrical function or connectivity.

In some examples, the display panel 18 may be selectively extended or retracted (e.g., such as by being rolled and un-rolled) during operations. In particular, display panel 18 may be selectively extended (e.g., un-rolled) along an axis 15 so as to selectively increase a viewable surface area of the display panel 18. In some examples, the axis 15 may be parallel to (and radially off-set from) the axis of rotation 17. Thus, display panel 18 may be considered an “actuatable member” of electronic device 10. In some examples, the display panel 18 may be extended in other directions, other than along axis 15. For instance, in some examples, display panel 18 may be extended along a direction that is perpendicular to axis 15 (e.g., and/or perpendicular to axis 17).

A motor 100 may be coupled to display panel 18 via a mechanical link 110. Motor 100 may comprise any suitable driver, such as, for instance, an electric motor (e.g., a stepper motor, servo motor), a pneumatic motor, hydraulic motor, etc. Motor 100 may include an output shaft 102 that is actuated (e.g., rotated, reciprocated) during operations. The actuation of output shaft 102 may selectively cause, via mechanical link 110, the extension or retraction of display panel 18 along axis 15 as previously described.

The mechanical link 110 may comprise shafts, gears, and/or other force transfer members that are to transmit the movement (e.g., rotation) of output shaft 102 to display panel 18. The motor 100 and output shaft 102 may be positioned within the second housing member 16, whereas the display panel 18 is supported within the first housing member 14. The placement of the motor 100 and display panel 18 within different housings (e.g., first housing member 14 and second housing member 16) may be due, for example, to limited space within the first housing member 14. As a result, the mechanical link 110 may extend across (or through) the hinge 13 to couple the output shaft 102 to the display panel 18, and the rotation of first housing member 14 about axis of rotation 17 via hinge 13 relative to second housing member 16 may cause actuation of the mechanical link 110. Actuation of the mechanical link 110, without a corresponding actuation of motor 100 may, in turn, cause unintentional actuation of display panel 18 and/or damage to motor 100 (e.g., due to forced rotation of output shaft 102).

Accordingly, a motor controller 150 (or more simply “controller 150”) is coupled to motor 100 that may selectively reduce a force (e.g., torque) applied by the motor 100 to the output shaft 102 to allow free movement (e.g., rotation) of output shaft 102 during rotation of the first housing member 14 and/or second housing member 16 about hinge 13. Without being limited to this or any other theory, free movement of the output shaft 102 may allow actuation of the mechanical link 110 (e.g., via rotation of first housing member 14 relative to second housing member 16 via hinge 13) to be dissipated at the output shaft 102 of motor 100, rather than at the display panel 18. As a result, the rotation of the first housing member 14 relative to second housing ember 16 about axis of rotation 17 via hinge 13 does not result in unintentional actuation of display panel 18. In addition, allowing free movement of the output shaft 102 may also prevent damage to the motor 100.

The controller 150 may comprise a processor 152 and a memory 154. The processor 152 may comprise any suitable processing device, such as a microcontroller, central processing unit (CPU), graphics processing unit (GPU), timing controller (TCON), scaler unit. The processor 152 executes machine-readable instructions (e.g., machine-readable instructions 156) stored on memory 154, thereby causing the processor 152 to perform some or all of the actions attributed herein to the controller 150. In general, processor 152 fetches, decodes, and executes instructions (e.g., machine-readable instructions 156). In addition, processor 152 may also perform other actions, such as, making determinations, detecting conditions or values, etc., and communicating signals. If processor 152 assists another component in performing a function, then processor 152 may be said to cause the component to perform the function.

The memory 154 may comprise volatile storage (e.g., random access memory (RAM)), non-volatile storage (e.g., flash storage, etc.), or combinations of both volatile and non-volatile storage. Data read or written by the processor 152 when executing machine-readable instructions 156 can also be stored on memory 154. Memory 154 may comprise “non-transitory machine-readable medium,” where the term “non-transitory” does not encompass transitory propagating signals.

The processor 152 may comprise one processing device or a plurality of processing devices that are distributed within electronic device 10. Likewise, the memory 154 may comprise one memory device or a plurality of memory devices that are distributed within the electronic device 10.

The controller 150 may be coupled to a sensor 160 that is to measure or detect a force (e.g., torque) applied to the hinge 13 due to rotation of the first housing member 14 and/or the second housing member 16 about axis of rotation 17 via hinge 13 during operations. For instance, when a user forcibly rotates the first housing member 14 about hinge 13 relative to second housing member 16, a force is transferred to the hinge 13 as a torque about axis of rotation 17. The sensor 160 may detect this applied torque and communicate the detected torque (or a value indicative thereof, such as pressure, force, etc.) to the controller 150.

During operations, the controller 150 may compare torque (or a corresponding value as previously described) detected by (or based on) sensor 160 with a threshold. If the torque (or corresponding value or parameter) detected by sensor 160 is above the threshold, then the controller 150 may actuate motor 100 to reduce a force applied to the output shaft 102 such that output shaft 102 may freely move (e.g., rotate) as previously described. If, on the other hand, the torque detected by sensor 160 is below (or equal to) the threshold, then the controller 150 may maintain the force on the output shaft 102, such that free movement of the output shaft 102 is restricted by motor 100.

In some examples, the controller 150 may analyze the torque applied to the hinge 13 (e.g., via sensor 160) using a proxy value to torque applied about axis of rotation 17. For instance, as previously noted, the controller 150 may analyze a pressure or a force applied to a surface or components of housing 12 or hinge 13, including comparing a threshold thereto. Thus, a value indicative of the torque (that may be analyzed by the controller 150 for controlling motor 100) may comprise torque itself, as well as other corresponding parameters or values.

In some examples, the threshold for the torque detected by sensor 160 that is applied by controller 150 may be less than a minimum torque applied to hinge 13 for rotating the first housing member 14 relative to second housing member 16 about axis of rotation 17 via hinge 13 during operations. In particular, a minimum torque may be applied to overcome friction within the components of hinge 13. This minimum torque may be intentionally designed into the hinge 13 to prevent rotation of the first housing member 14 and/or second housing member 16 about axis of rotation 17 without an input force (e.g., from a user). By selecting the threshold to be less than this minimum amount of torque for rotating the first housing member 14 or the second housing member 16, the controller 150 may actuate motor 100 to reduce the force applied to the output shaft 102 prior to any movement of the first housing member 14 about hinge 13 relative to second housing member 16. In some examples, the torque (or proxy value thereof) may be approximately 5%, 10%, 20%, 30%, etc. less than the minimum torque (again, or proxy value thereof) for rotating the first housing member 14 and/or the second housing member 16 about axis of rotation 17 via hinge 13.

As shown in FIG. 1, the mechanical link 110, motor 100, controller 150, and/or sensor 160 may be internally positioned within the housing 12 of electronic device 10 (e.g., in the first housing member 14 or second housing member 16 as previously described). Thus, these features are shown with broken lines in FIG. 1.

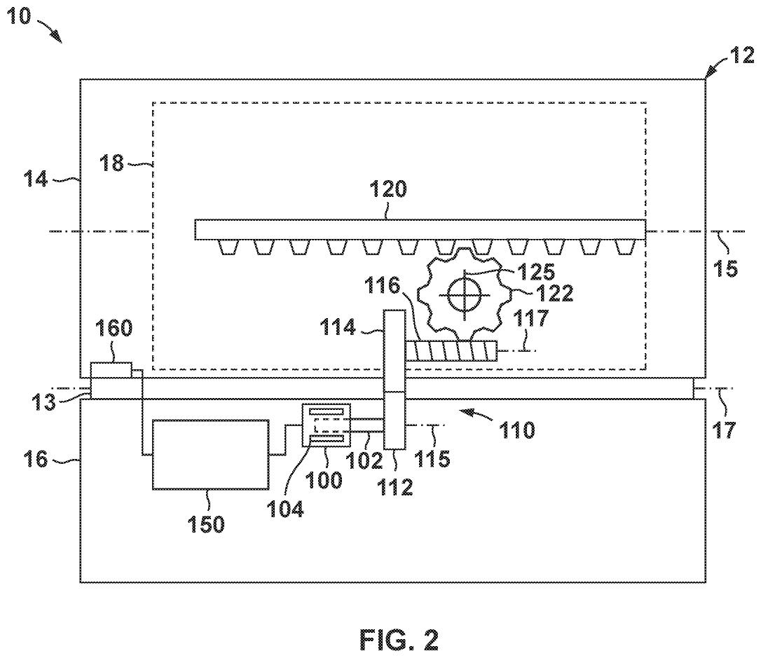

Referring now to FIG. 2, in some examples, mechanical link 110 comprises a plurality of gears that are coupled across hinge 13 as previously described. In particular, in some examples, the plurality of gears of mechanical link 110 comprises an output gear 112 coupled to output shaft 102 of motor 100. During operations, motor 100 may rotate output shaft 102 and output gear 112 about an axis 115 that is parallel to (and radially offset from) axis of rotation 17 of hinge 13. The output gear 112 may be meshed with a normal gear 114 so that rotation of the output gear 112 about axis 115 causes rotation of normal gear 114 about an axis 117 that is parallel to (and radially offset from) axis 115. The normal gear 114 may be positioned (e.g., partially positioned) within the first housing member 14, and the output gear 112 may be positioned (e.g., partially positioned) within second housing member 16 such that the output gear 112 and normal gear 114 may be meshed or engaged across (or through) the hinge 13.

A worm gear 116 may be coupled to, engaged with, or integrated with normal gear 114 so that rotation of the normal gear 114 about axis 117 also causes rotation of worm gear 116 about axis 117. The worm gear 116 is meshed with a pinion gear 122 such that rotation of worm gear 116 about axis 117 causes a rotation of pinion gear 122 about an axis 125 that may extend in a direction that is perpendicular to a direction of the axes 15, 17, 115, 117. The pinion gear 122 is engaged with a toothed rack 120 that is in turn coupled to display panel 18.

During operations, motor 100 is to rotate output shaft 102 and output gear 112 about axis 115, which in turn causes a rotation of normal gear 114 and worm gear 116 about axis 117. Further, the rotation of worm gear 116 about axis 117 causes a rotation of pinion gear 122 about axis 125, which in turn axially translates toothed rack 120 and extends or retracts display panel 18 along axis 15. In some examples, multiple pinion gears 122 and/or toothed racks 120 may be coupled to worm gear 116 so as to facilitate extension or retraction of both lateral ends of display panel 18 via motor 100 during operations.

Because the output gear 112 and normal gear 114 are engaged with one another across hinge 13 as previously described, the forced rotation of the first housing member 14 relative to second housing member 16 about hinge 13 (e.g., by a user) may cause rotation of one or both of the gears 112, 114. Thus, as previously described, controller 150 may detect the input force (e.g., torque) applied to the hinge 13 via sensor 160 and actuate motor 100 to reduce a force applied to output shaft 102 and thereby allow the free rotation thereof. In some examples, the rotational resistance (e.g., due to friction) of the output shaft 102, when released by motor 100, may be less than the resistance (e.g., again due to friction) of the gears 114, 116, 122, and toothed rack 120. As a result, once the motor 100 reduces a force applied to the output shaft 102 (e.g., to allow free rotation thereof), the rotation of the first housing member 14 relative to second housing member 16 about hinge 13 may result in the free rotation of output shaft 102 about axis 115 and not the rotation or movement of the gears 114, 116, 122 and toothed rack 120.

In some examples, the motor 100 may comprise an electric motor as previously described. Thus, in some examples, the motor 100 may comprise one (or a plurality of) conductive (e.g., electrically conductive) windings 104. The conductive winding(s) 104 may comprise conductive wire that may be energized with electric current to generate magnetic fields for causing rotation of output shaft 102 during operations. Even when not rotating output shaft 102, the conductive winding(s) 104 (or some thereof) of motor 100 may be supplied with electric current to hold or maintain a rotational position of output shaft 102 about axis 115 during operations. Thus, in some examples, controller 150 may actuate motor 100 to reduce a force on the output shaft 102 by de-energizing the motor 100 (or perhaps the conductive winding(s) 104 thereof) so as to reduce (or eliminate) the magnetic fields within motor 100 and allow the free rotation of output shaft 102.

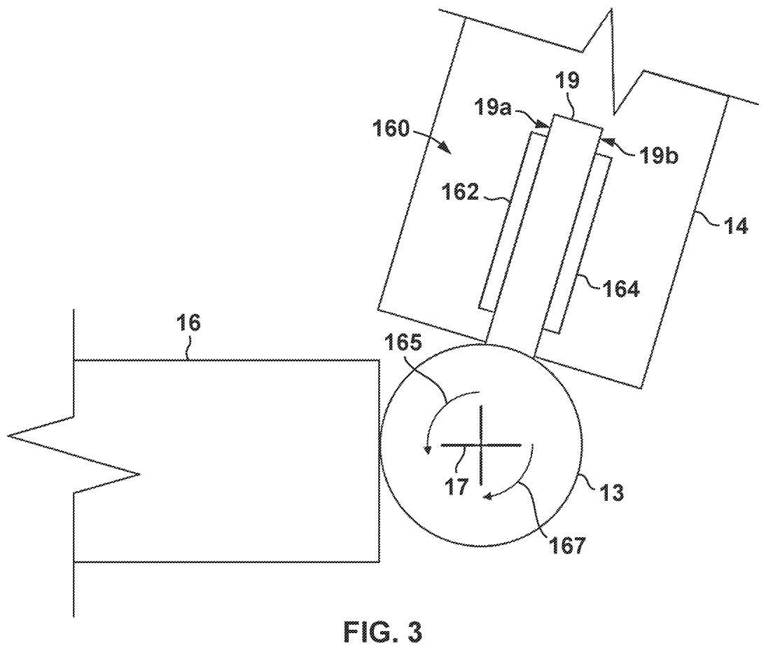

Referring now to FIG. 3, in some examples, the sensor 160 for measuring the torque (or other proxy value) on the hinge 13 may comprise any suitable sensor (or sensor array) for measuring or detecting torque, force, pressure, strain, etc. applied to the hinge 13 when rotating the first housing member 14 or second housing member 16 about hinge 13 during operations. For instance, in some examples, the sensor 160 may comprise a first sensor 162 and second sensor 164 coupled to hinge 13.

The first sensor 162 and second sensor 164 may comprise thin-film pressure sensors, such as, pressure-sensitive resistors (PSRs) that are coupled to a bracket 19 of hinge 13. During operations, a user may push or pull on the first housing member 14 to rotate the first housing member 14 about axis of rotation 17 via hinge 13, and the force exerted on the first housing member 14 by the user may be transferred through the first housing member 14 to hinge 13. This transferred force may result in a pressure or force applied to one or both of the first sensor 162 and second sensor 164 via bracket 19.

The first sensor 162 and second sensor 164 may be secured to opposing sides of bracket 19, so that first sensor 162 and second sensor 164 may detect torque on the hinge 13 in the first direction 165 and second direction 167, respectively, about axis of rotation 17. In particular, the different torque directions 165, 175 may be associated with different rotational directions of first housing member 14 and/or second housing member 16 about axis of rotation 17 during operations.

For instance, the first sensor 162 is coupled to a first side 19a of bracket 19 so that when a force is applied to first housing member 14 to rotate first housing member 14 in a first direction 165 about axis of rotation 17 relative to second housing member 16, the torque applied to hinge 13 in first direction 165 results in a corresponding pressure on the first sensor 162. Conversely, the second sensor 164 is coupled to a second side 19b of bracket 19 so that when a force is applied to first housing member 14 to rotate the first housing member 14 in a second direction 167 about axis of rotation 17 relative to second housing member 16, the torque applied to hinge 13 in second direction 167 results in a corresponding pressure on the second sensor 164. The second side 19b of bracket 19 may be opposite the first side 19a, and likewise, the second direction 167 may be opposite the first direction 165 about axis of rotation 17. The first sensor 162 and second sensor 164 may output the detected pressures (e.g., or values indicative thereof) to the controller 150 (FIG. 1) which may then determine, based on the output from first sensor 162 and second sensor 164, whether the torque (or proxy value thereof) applied to the hinge 13 is above or equal to the threshold as previously described.

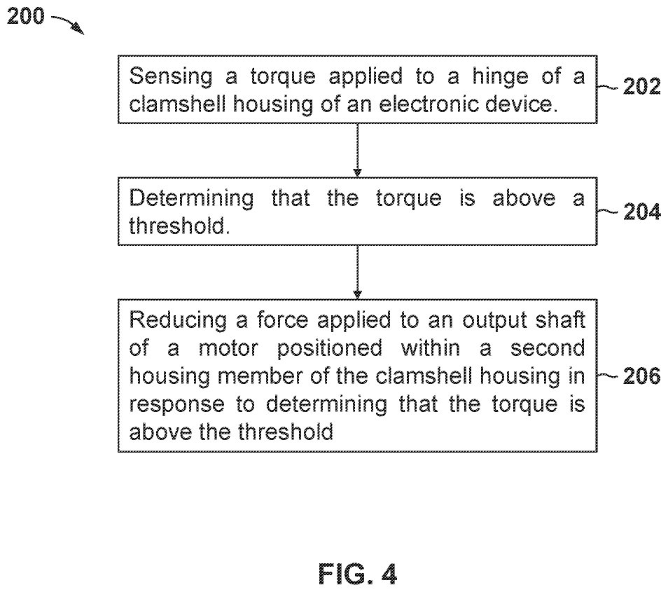

Referring now to FIG. 4, a method 200 for controlling a motor within an electronic device based on hinge torque according to some examples is shown. In some examples, the method 200 may be performed via the electronic device 10 described herein; however, other electronic devices may be used to perform method 200 in other examples. Thus, in describing the features of method 200, continuing reference is made to electronic device 10 and components thereof shown in FIGS. 1-3 and described above. However, other electronic devices may be used to perform method 200 in other examples.

Method 200 includes sensing a torque applied to a hinge of a clamshell housing of an electronic device at block 202. For instance, as previously described for electronic device 10, a sensor 160 (e.g., comprising a first sensor 162 and second sensor 164 as shown in FIG. 3) may detect a force, pressure, or other suitable value associated with a torque applied to a hinge 13 of electronic device 10 by a user when rotating the first housing member 14 about hinge 13 relative to second housing member 16 (FIGS. 1-3).

In addition, method 200 includes determining that the torque is above a threshold at block 204. For instance, as previously described for electronic device 10, controller 150 may compare the determined or detected torque (or proxy value thereof) applied to the hinge 13 with a threshold value. The threshold value may be based on the minimum torque for overcoming the rotational resistance (e.g., friction, inertia) of the hinge 13 and rotating the first housing member 14 and/or the second housing member 16 about hinge 13 during operations. For instance, as previously described, in some examples, the threshold value may comprise a value that is (or corresponds to) a value of torque that is less than the minimum torque on hinge 13 for rotating first housing member 14 and/or second housing member 16 about hinge 13. In some examples, the threshold value may be approximately 5%, 10%, 20%, 30%, etc. less than the minimum torque on hinge 13 for rotating first housing member 14 and/or second housing member 16 about hinge 13.

Further, method 200 includes reducing a force applied to an output shaft of a motor positioned within a second housing member of the clamshell housing in response to determining that the torque is above the threshold at block 206. For instance, as previously described for electronic device 10, once controller 150 determines that the torque applied to hinge 13 is above the threshold value, the controller 150 may reduce a force applied by motor 100 to its output shaft 102 so as to allow the free rotation thereof. In some examples, reducing the force applied to the output shaft (e.g., output shaft 102) may comprise de-energizing the motor 100 or conductive winding(s) 104 thereof. In some examples, reducing the force applied to the output shaft (e.g., output shaft 102) may comprise disengaging a clutch within or coupled to motor 100.

In some examples, the motor (e.g., motor 100) may be used to actuate an actuatable member of the electronic device. For instance, for the electronic device 10 of FIGS. 1-3, the motor 100 may extend or retract the flexible display panel 18. In some examples, one of the housing members 14, 16 of the housing 12 may comprise an “actuatable member,” so that the motor 100 may cause rotation of the first housing member 14 relative to the second housing member 16 (or vice versa) during operations.

As described, the examples disclosed herein include electronic devices (and methods related thereto) that mechanically link a motor and an actuatable member across multiple pivotable housing members. Some examples disclosed herein may employ systems to prevent both damage to the motor or linkage and unintentional actuation of the actuatable member resulting from forces (e.g., torque) exerted on the housing members and/or the hinge(s) coupled thereto. Thus, through use of the examples disclosed herein, a motor may be distally located (e.g., in another housing member) from an actuatable member of an electronic device without reducing the functionality or reliability thereof.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the discussion above and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis.

As used herein, including in the claims, the word “or” is used in an inclusive manner. For example, “A or B” means any of the following: “A” alone, “B” alone, or both “A” and “B.” In addition, when used herein including in the claims, the word “generally” or “substantially” means within a range of plus or minus 10% of the stated value.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An electronic device, comprising:
a housing comprising a first housing member and a second housing member pivotably coupled to one another via a hinge;
a motor positioned in the second housing member comprising an output shaft;
an actuatable member positioned in the first housing member, wherein the motor is to actuate the actuatable member via a plurality of gears coupled across the hinge; and
a controller coupled to the motor, wherein the controller is to actuate the motor to reduce a force applied to the output shaft in response to detecting a torque on the hinge.

2. The electronic device of claim 1, comprising a sensor coupled to the hinge, wherein the controller is to detect the torque on the hinge via the sensor.

3. The electronic device of claim 1, comprising a first sensor coupled to the hinge that is to detect the torque on the hinge in a first direction and a second sensor coupled to the hinge that is to detect the torque on the hinge in a second direction that is opposite the first direction.

4. The electronic device of claim 1, wherein the controller is to reduce the force applied to the output shaft by de-energizing a conductive winding of the motor.

5. The electronic device of claim 1, wherein the controller is to determine that the torque is above a threshold, wherein the threshold is less than a minimum torque applied to the hinge to rotate the first housing member relative to the second housing member about the hinge.

6. The electronic device of claim 1, wherein the actuatable member comprises a flexible display panel supported by the first housing member, wherein the motor is to extend and retract the flexible display panel.

7. The electronic device of claim 6, wherein the plurality of gears comprises a pinion gear coupled to the motor and a toothed rack that is coupled to the flexible display panel.

8. An electronic device, comprising:
a clamshell housing having a first housing member and a second housing member pivotably coupled to one another via a hinge;
a flexible display panel supported by the first housing member;
a motor positioned within the second housing member that is coupled to the flexible display panel, wherein the motor is to extend and retract the flexible display panel;
a sensor coupled to the hinge to detect a torque applied to the hinge via the first housing member and the second housing member; and
a controller coupled to the motor and the sensor, wherein the controller is to de-energize the motor in response to detecting a torque applied to the hinge via the sensor.

9. The electronic device of claim 8, wherein the torque is less than a minimum torque applied to the hinge to rotate the first housing member relative to the second housing member about the hinge.

10. The electronic device of claim 9, wherein the torque is approximately 10% less than the minimum torque applied to the hinge to rotate the first housing member relative to the second housing member about the hinge.

11. The electronic device of claim 8, wherein the sensor comprises a pressure sensor coupled to the hinge.

12. The electronic device of claim 11, wherein the pressure sensor comprises a pressure-sensitive resistor.

13. The electronic device of claim 8 comprising a plurality of gears coupled between the motor and the flexible display panel, wherein the plurality of gears are coupled across the hinge.

14. The electronic device of claim 8, wherein the motor includes an output shaft, and wherein the output shaft is to rotate freely when the motor is de-energized.

15. A method, comprising:
sensing a torque applied to a hinge of a clamshell housing of an electronic device;
determining that the torque is above a threshold; and
reducing a force applied to an output shaft of a motor positioned within a second housing member of the clamshell housing in response to determining that the torque is above the threshold, wherein the motor is to extend and retract a flexible display panel supported in a first housing member of the clamshell housing.

16. The method of claim 15, wherein sensing the torque comprises receiving an output from a sensor coupled to the hinge.

17. The method of claim 15, wherein sensing the torque comprises detecting the torque applied to the hinge in a first direction with a first pressure sensor or detecting the torque applied to the hinge in a second direction with a second pressure sensor.

18. The method of claim 15, wherein reducing the force applied to the output shaft comprises de-energizing a conductive winding of the motor.

19. The method of claim 15, comprising:
determining that the torque is below the threshold; and
maintaining the force applied to the output shaft in response to determining that the torque is above the threshold.

20. The method of claim 15, comprising rotating the output shaft via the torque after reducing the force applied to the output shaft.
